(19) United States
(12) Patent Application Publication
(10) Pub. No.: US 2026/0023985 A1
(43) Pub. Date: Jan. 22, 2026

(54) METHODS AND APPARATUS TO PERFORM ARTIFICIAL INTELLIGENCE-BASED SPARSE COMPUTATION BASED ON HYBRID PATTERN AND DYNAMIC ENCODING

(71) Applicant: Intel Corporation, Santa Clara, CA (US)

(72) Inventors: Hengyu Meng, Shanghai (CN); Hanwen Chang, Taipei City (CN); Haihao Shen, Shanghai (CN)

(73) Assignee: Intel Corporation, Santa Clara, CA (US)

(21) Appl. No.: 18/995,722

(22) PCT Filed: Sep. 29, 2022
(86) PCT No.: PCT/CN2022/122915

§ 371 Date: Jan. 16, 2025

(51) Int. Cl. G06N 3/0985; G06N 3/0495

(52) U.S. Cl. CPC G06N 3/0985; G06N 3/0495

(57) ABSTRACT

Methods, apparatus, systems, and articles of manufacture to perform artificial intelligence-based sparse computation based on hybrid pattern and dynamic encoding are disclosed. An example apparatus includes memory, computer readable instructions, and processor circuitry to execute the computer readable instructions to: determine a hybrid sparse pattern of a selected layer of an artificial intelligence (AI)-based model, the hybrid sparse pattern having a sparsity ratio and a block pattern for the selected layer; in response to the sparsity ratio being above a threshold, reduce the sparsity ratio of the selected layer; and in response to the sparsity ratio being below the threshold, adjust the block pattern of the selected layer, the block pattern of the selected layer corresponding to an accuracy ratio.

### FIELD OF THE DISCLOSURE

This disclosure relates generally to machine learning, and, more particularly, to methods and apparatus to perform artificial intelligence-based sparse computation based on hybrid pattern and dynamic encoding.

### BACKGROUND

In recent years, artificial intelligence (e.g., machine learning, deep learning, etc.) have increased in popularity. Artificial intelligence may be implemented using neural networks. Neural networks are computing systems inspired by the neural networks of human brains. A neural network can receive an input and generate an output. The neural network includes a plurality of neurons corresponding to weights that can be trained (e.g., can learn, be weighted, etc.) based on feedback so that the output corresponds a desired result. Once the weights are trained, the neural network can make decisions to generate an output based on any input. Neural networks are used for the emerging fields of artificial intelligence and/or machine learning. A deep neural network is a particular type of neural network that includes multiple layers of neurons between an input and an output.

### BRIEF DESCRIPTION OF THE DRAWINGS

FIG. 1 is a schematic illustration of an example artificial intelligence-based model.

FIG. 2 is a block diagram of example implementation of model training circuitry of FIG. 1.

FIGS. 3-5 illustrate a flowchart representative of example machine readable instructions which may be executed to implement the example model training circuitry of FIGS. 1 and/or 2.

FIG. 6 illustrates an example of the dynamic sparse encoding.

FIG. 7 is a block diagram of an example processing platform structured to execute the instructions of FIGS. 3-5 to implement the example model training circuitry of FIGS. 1 and/or 2.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform to distribute software (e.g., software corresponding to the example computer readable instructions of FIGS. 3-5 to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Although the figures show layers and regions with clean lines and boundaries, some or all of these lines and/or boundaries may be idealized. In reality, the boundaries and/or lines may be unobservable, blended, and/or irregular.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but may be used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Artificial intelligence (AI)-based models, such as machine learning models, deep learning models, neural networks, deep neural networks, etc. are used to perform a task (e.g., classify data). An AI-based model may be trained using ground truth data (e.g., data correctly labelled with a particular classification). Training a traditional AI-model adjusts the weights of neurons of the neural network. After trained, data is input into the trained neural network and the weights of the neurons are applied (e.g., multiplied and accumulate (MAC)) to input data to be able to process the input data to perform a function (e.g., classify data). For example, each neuron can be implemented by a MAC processing element (PE) that obtains input data and/or output data of a previous layer (e.g., activation data) and multiplies the input/activation data with the weights developed from training to generate output values for the neuron. As used herein, the terms data element and activation are interchangeable and mean the same thing. In particular, as defined herein, a data element or an activation is a compartment of data in a data structure. The output values may be transmitted to a subsequent layer and/or another component (e.g., a classifier to classify the output data). As used herein, an activation tensor (e.g., also referred to as an activation matrix) is input data and/or output data from a particular layer of an AI-based model and a weight tensor (e.g., also referred to as a weight matrix) is a set of weight for a particular layer.

A technique to improve performance and reduce energy consumption is by exploiting the property of sparsity that is present in abundance in the networks. Sparsity refers to the existence of zeros in weights and activations in AI-based models. Zero valued activations in AI-based models stem from the processing of the layers through activation functions, whereas zero valued weights usually arise due to filter pruning or due to the process of quantization in AI-based models. These zero valued activations and weights do not contribute towards the result during MAC operations in convolutional and fully-connected layers and hence, they can be skipped during both computation and storage. Accordingly, machine learning accelerators can exploit this sparsity available in activations and weights to achieve significant speedup during compute, which leads to power savings because the same work can be accomplished using less energy, as well as reducing the storage requirements for the weights (and activations) via efficient compression schemes. Both reducing the total amount of data transfer across memory hierarchies and decreasing the overall compute time are critical to improving energy efficiency in machine learning accelerators.

Examples disclosed herein relate to an AI-based model where less than a threshold number of parameters are non-zero (e.g., sparse activation and/or weight data). Sparsification is an optimization technique used to reduce the computation and memory footprint for AI-based workloads. Model sparsity and/or compression should balance accuracy of the AI-based model with performance of the AI-based model because increasing performance of the AI-based model may lead to lower accuracy of the AI-based model. As used herein, structural sparsity (also referred to as block-wise sparsity) refers to processing a matrix that has been divided into non-overlapping blocks, where blocks full of zeros are treated as zero blocks and blocks including at least one non-zero element are treated as non-zero block.

Examples disclosed herein generate a hybrid sparse pattern (also referred to as a hybrid block pattern) to balance accuracy and performance based on adjusting the sparsity ratio and block size when generating the hybrid sparse pattern. They hybrid sparse pattern of a layer of an AI-based model includes a sparsity ratio and a block pattern of the layer. A sparsity ratio (also referred to as a sparse ratio) is the ratio of zero blocks to all the blocks in a group. The higher the sparsity the more non zero elements, which corresponds to a higher accuracy drop but a performance gain. The bigger the block size, the higher the accuracy drop but the more the performance gain. A hybrid sparse pattern is a mixture of one or more kinds of sparse patterns (also referred to as block patterns) with configurable parameters. For example, if block-wise sparsity is applied to a deep learning model, the sizes of the block may vary for each general matrix to matrix multiplication (GEMM) layer due to accuracy constraints. Sparsity closer to the input/output layers of the model with smaller block sizes provide higher accuracy while middle layers benefit from larger block sizes to benefit performance. However, designing sparse pattern for each convolution or GEMM layer is difficult or impossible because the relations between model weight and accuracy is currently a black box. Examples disclosed herein provide a technique for generating a sparse model that corresponds to a hybrid sparse pattern during training to raise the sparsity ratio to improve performance while maintaining high accuracy.

Additionally, examples disclosed herein perform a dynamic sparse encoding designed for the disclosed hybrid sparse pattern to increase hardware efficiency. Non-zero elements distribute randomly in a sparse matrix and hybrid patterns may introduce additional randomness. The randomness limits the utilization of modern central process unit (CPU) and/or modern accelerator single instruction, multiple data (SIMD), thereby decreasing hardware efficiency. Examples disclosed herein provide a dynamic sparse encoding technique instead of conventional static sparse encoding and a corresponding auto-generated kernel to achieve a balance between performance and accuracy. The dynamic sparse encoding is designed for the hybrid sparse pattern and will adjust encoding parameters to increase density of computation for better hardware efficiency. Additionally, examples disclosed herein provide a kernel generator to generate a specific kernel corresponding to specific weights based on dynamic sparse encoding results.

In general, implementing a machine learning (ML)/artificial intelligence (AI) system involves two phases, a learning/training phase, and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters may be used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, training is performed until a threshold number of actions have been predicted. In examples disclosed herein, training is performed either locally (e.g., in the device) or remotely (e.g., in the cloud and/or at a server). Training may be performed using hyperparameters that control how the learning is performed (e.g., a learning rate, a number of layers to be used in the machine learning model, etc.). In some examples, re-training may be performed. Such re-training may be performed in response to a new program being implemented or a new user using the device. Training is performed using training data. When supervised training may be used, the training data is labeled. In some examples, the training data is pre-processed.

Once training is complete, the model is deployed for use as an executable construct that processes an input and provides an output based on the network of nodes and connections defined in the model. The model is stored locally in memory (e.g., cache and moved into memory after trained) or may be stored in the cloud. The model may then be executed by the processors.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

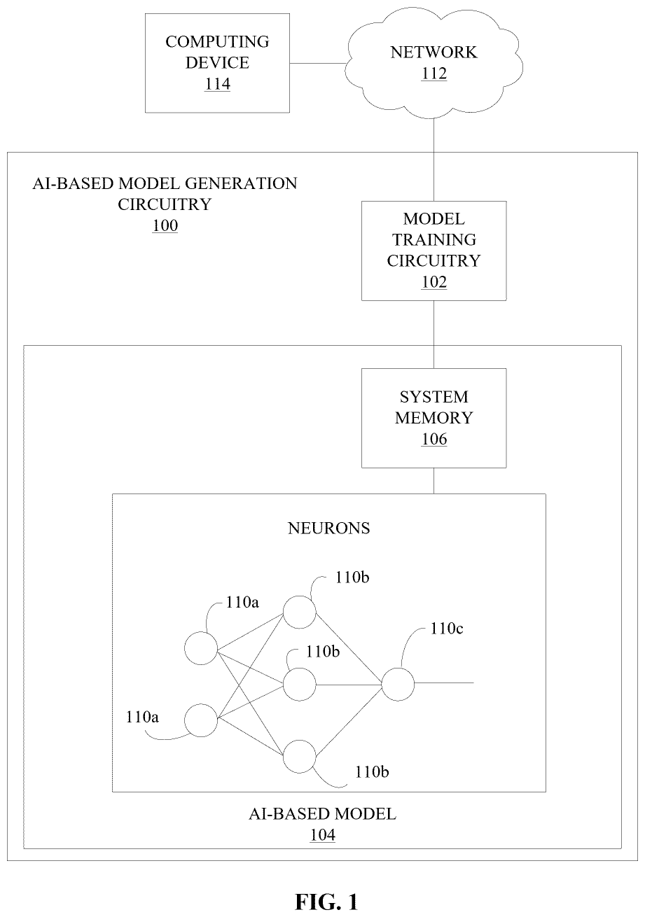

FIG. 1 is a schematic illustration of an example model training circuitry 102 to train an example AI-based model 104. The example AI-based model 104 includes an example system memory 106 and layers of example neurons (herein referred to as neurons, compute nodes, processing elements, etc.) 110a-c. Although the illustrated neurons 110a-c of FIG. 1 include six neurons in three layers, there may be any number of neurons in any type of configuration. Although the example of FIG. 1 is described in conjunction with the AI-based model 104, examples disclosed herein may be utilized in any AI-based system or model that includes weights.

The example model training circuitry 102 of FIG. 1 trains the AI-based model 104 by selecting weights (e.g., formed in a vector or matrix) for each of the neurons 110a-c. Initially, the AI-based model 104 is untrained (e.g., the neurons are not yet weighted and/or or only initially weighted). To train the AI-based model 104, the example model training circuitry 102 of FIG. 1 uses training data (e.g., input data labeled with known classifications and/or outputs) to configure the AI-based model 104 to be able to predict output classifications for input data with unknown classifications. In some examples, the model training circuitry 102 may train a model with a first set of training data and test the model with a second set of the training data. If, based on the results of the testing, the accuracy of the model is below a threshold, the model training circuitry 102 can tune (e.g., adjust, further train, etc.) the parameters of the model using additional sets of the training data and continue testing until the accuracy is above the threshold. After the model training circuitry 102 has trained the AI-based model 104, the example model training circuitry 102 stores the corresponding means and deviations for the respective neurons 110a-c in the example system memory 106 of the example AI-based model 104. The example model training circuitry 102 may be implemented in the same device as the AI-based model 104 and/or in a separate device (e.g., the computing device 114) in communication with the example AI-based model 104. For example, the model training circuitry 102 may be located remotely, develop the weight data locally, and deploy the weight data (e.g., a vector/matrix of weights to be implemented by corresponding neurons 110a-c) to the AI-based model 104 for implementation (e.g., application of the eights to activations by a MAC operation) via the example network 112.

In some examples, the model training circuitry 102 of FIG. 1 trains the AI-model 102 for sparsity. As described above, the higher the sparsity ratio of a trained weight tensor (e.g., the more zero block and/or elements), the better the performance but the higher the accuracy drop. Additionally, the bigger the block size (e.g., sparse pattern) for the elements, the better the performance but the higher the accuracy drop. Accordingly, the model training circuitry 102 of FIG. 1 selects a sparsity ratio and/or block size for each layer of weights to balance performance and accuracy. Each layer may have a different sparsity ratio and/or block size to achieve high accuracy and low latency. The sparse pattern may correspond to a block size and/or dimensions. For example, a sparse pattern may correspond to a block size of 8 (e.g., corresponding to dimensions 1 by 8), a block size of 4 (e.g., corresponding to dimensions 1 by 4), a block size of 2 (e.g., corresponding to dimensions 1 by 2), and/or any other block size. A block may include a single weight value or a group of weight values for a particular layer.

To improve accuracy, the example model training circuitry 102 of FIG. 1 generates a hybrid sparse pattern (e.g., including a sparsity ratio and a block size for the trained AI-based model) by adjusting the sparsity ratio and/or block size for every k epoch during training. An epoch is a pass of a training dataset in though the AI-based model. Training the AI-based model 102 typically includes multiple (e.g., k) epochs. For a particular epoch, the model training circuitry 102 evaluates the accuracy of the AI-based model 104 based on a comparison of the output data of the AI-based model 104 to the labeled output of the training data. If the accuracy of the AI-based model 104 satisfies a user and/or manufacturer-defined threshold, the model training circuitry 102 processes a different layer and/or epoch. If the accuracy of the AI-based model 104 does not satisfy the threshold, the model training circuitry 102 determines if the sparse ratio of the selected layer is higher than a user and/or manufacturer-defined threshold, the model training circuitry 102 reduces a sparse ratio for the layer and the process continues to another layer and/or epoch. The model training circuitry 102 may reduce the sparse ratio (e.g., reduce the number of zero elements for the layer) based on a user and/or manufacturer defined hyperparameter(s) that corresponds to how aggressive the sparse ratio is reduced by. The model training circuitry 102 determines an accuracy loss ratio (e.g., also referred to as an accuracy ratio) based on a ratio of the loss of structure (e.g., the accuracy loss) and the accuracy loss of n in m is greater than a user-selected hyperparameter t (e.g., a threshold corresponding to a user and/or device defined loss target). The loss of structure corresponds to an accuracy loss (e.g., based on a comparison of the output of the AI-based model to a labelled output of the labeled data). An n in m sparsity pattern corresponds to n number of zero items in the pattern and m number of total items in the pattern for the layer. The example model training circuitry 102 may determine the accuracy loss of n in m (e.g., by calculating the accuracy loss and/or by identifying the accuracy loss stored in a table, register, memory, etc.). If the model training circuitry 102 determines that the accuracy loss ratio is greater than a user-selected hyperparameter, the model training circuitry 102 changes the sparse pattern. For example, the model training circuitry 102 may reduce the block size used the sparsity pattern from an initial preset size (e.g., 1 by 8) to a smaller size (e.g., 1 by 4). A smaller block size pattern will generally resulting in an increase in accuracy (e.g., at the detriment of performance). Accordingly, the model training circuitry 102 may reduce block sizes until the threshold accuracy is achieved. If the block size is already at a minimum size (e.g., a block size or 2), the model training circuitry 102 will utilize a n in m (e.g., 2 in 4) sparsity pattern for the layer based on user and/or manufacturer preferences. The model training circuitry 102 may utilize NVIDIA to break up and/or adjust the weight tensor into smaller elements of n in m groups.

In some examples, the model training circuitry 102 of FIG. 1 can estimate performance of the sparse AI-based model as compared to a dense AI-based model. For example, the model training circuitry 102 can compare a dense GEMM to a 1 by 4 sparse kernel that loads activation matrix before fuse multiply add (FMA) operation. In such an example, for each FMA, the sparse kernel will take 132 cycles (e.g., 4*(3+6+3+1)+16*5, because there are four cycles of operations that correspond to 3 cycles, 6 cycles, 3 cycles, and 1 cycle and 16 FMA instructions that each include 5 cycles), and dense operation reuses the activation block to do the FMA and can ignore the load overhead, resulting in 80 cycles (e.g., 16*5). Thus, the model training circuitry 102 can determine that, for an example sparse ratio of 90%, the maximum performance of a 1 by 4 kernel will be 6.06 (e.g., 100/(100−90)*(80/132)). The 6.06 ratio corresponds to the upper limit of performance (e.g., performance is 6.06 times better than conventional dense AI-based models). The training circuitry 102 determines the performance ratio to identify the upper limit of performance gain so that performance can be increased during training of the AI-based model 104.

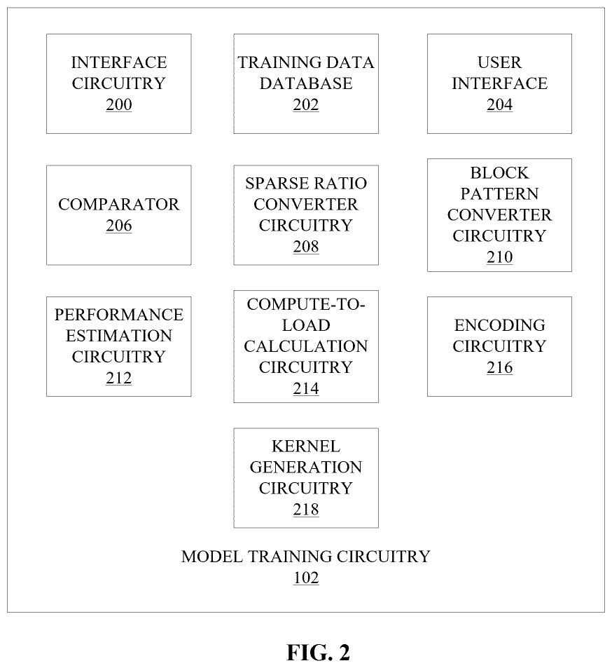

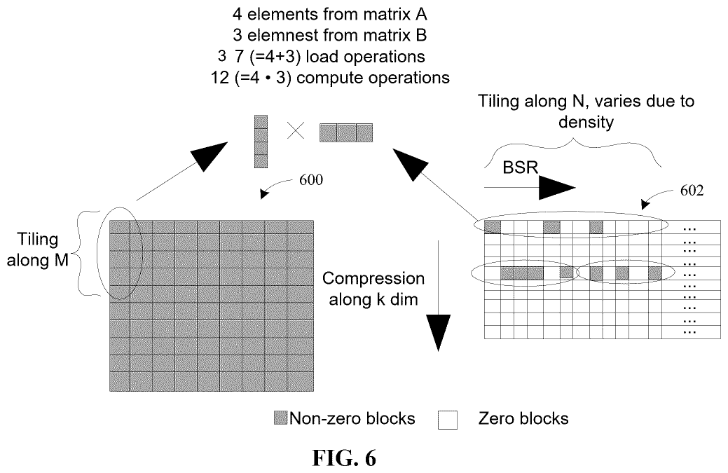

Additionally, the model training circuitry 102 encodes the sparse AI-based model 102 using a dynamic sparse encoding scheme. Conventional encoding schemes utilize fixed tile sizes for each row of a weight tensor for encoding and later performing an FMA operation. However conventional encoding schemes can result in poor compute-to-load ratios associated with the FMA operation that result in poor hardware efficiency. To increase hardware efficiency, the model training circuitry 102 increases the compute-to-load ratios by maximizing the dot product operations and minimizing the load operations by compressing several blocks in several columns per row of the weight tensor. For example, the model training circuitry 102 calculates the best tile size for each row when encoding to improve, increase, and/or maximize the compute-to-load ratios for the row of the weight tensor. The model training circuitry 102 may attempt different tile sizes for a row, compute the compute-to-load ratios for the different configurations, and select a tile size configuration based on the highest compute-to-load ratio to increase hardware efficiency. An example of dynamic encoding is further described below in conjunction with FIG. 6. The example NN trainer is further described below in conjunction with FIG. 2.

The example AI-based model 104 of FIG. 1 includes the example system memory 106. The example system memory 106 stores the generate encoded weights (e.g., encoded weight vectors or matrices) for the example model training circuitry 102 in conjunction with a particular neuron. During implementation, the AI-based model 104 accesses the stored encoded weight vectors and transmits to the corresponding neurons 110a-c to be applied to activation data.

The example neurons 110a-c of FIG. 1 are structured in the layers. As further described below, the neurons 110a-c are implemented by processing elements including, or in communication with, MAC processing elements. The example neurons 110a-c receive input/activation data (e.g., structured in a vector/matrix), apply weights (e.g., structured in a vector/matrix) to the input/activation data to generate outputs (e.g., structured as a vector/matrix). The MAC PE may perform a multiplication and accumulation process to the activations and corresponding weights.

After the AI-based model 104 of FIG. 1 is trained, the example model training circuitry 102 deploys (e.g., transmits via one or more network communications) the encoded weight data to the example computing device 114 via the network 112. The example network 112 is a system of interconnected systems exchanging data. The example network 112 may be implemented using any type of public or private network such as, but not limited to, the Internet, a telephone network, a local area network (LAN), a cable network, and/or a wireless network. To enable communication via the network 112, the example AI-based model generation circuitry 100 includes a communication interface that enables a connection to an Ethernet, a digital subscriber line (DSL), a telephone line, a coaxial cable, or any wireless connection, etc. In some examples, the AI-based model generation circuitry 100 and the example computing device 114 are connected via the example network 116.

The example computing device 114 of FIG. 1 obtains the encoded weight data from the example AI-based model generation circuitry 110 via the network 112. The example computing device 114 can decode the encoded weight data based on the dynamic sparse encoding technique to implement the AI-based model locally at the computing device to perform one or more tasks.

FIG. 2 is a block diagram of the example model training circuitry 102 of FIG. 1. The example model training circuitry 102 includes example interface circuitry 200, an example training data database 202, an example user interface 204, an example comparator 206, example sparse ratio converter circuitry 208, example block pattern converter circuitry 210, example performance estimation circuitry 212, example computer-to-load calculation circuitry 214, example encoding circuitry 216, and example kernel generation circuitry 218.

The example interface circuitry 200 of FIG. 2 obtains (e.g., receives, accesses, etc.) encoded weights (e.g., a vector/matrix of weights) from the example system memory 106 and deploys (e.g., transmits using one or more network communications) the encoded weights to the computing device 114 via the network 112. As described above, the weights are based on training to configure the AI-based model 104 to perform a task (e.g., classify input data). Additionally, the example interface circuitry 200 may obtain (e.g., receive, access, etc.) the training data used to train the example AI-based model 104 via a network communication and stored the obtained training data in the example training data database 202. The example interface circuitry also stores encoded weight information in the example system memory 106 of FIG. 1 after the AI-based model 104 is trained. The example training data database 202 may be implemented by storage, buffers, memory, registers, etc. to store training data.

The example user interface 204 of FIG. 2 obtains AI-based model characteristics and/or hyperparameters from a user. For example, a user can interact with the user interface 204 to provide characteristics and/or hyperparameters related to the number of layers of the AI-based model, the number and/or structure of neurons in the AI-based model, the number of epochs for training, the threshold and/or desired accuracy of the AI-based model, the threshold sparse ratio of the layers, the number and/or type block patterns to utilize, the threshold block size, and/or any other data related to the generation of a sparse AI-based model.

The example comparator 206 (also referred to as comparator circuitry) of FIG. 2 compares attributes of the AI-based model 104 to one or more threshold as part of the training process. For example, the comparator 206 can compare (a) the accuracy of the AI-based model to an accuracy threshold, (b) sparse ratios of one or more layers to a sparse ratio threshold, and/or (c) block sizes of block patterns to a block size ratio. The comparator 206 may access the one or more thresholds from a user via the example user interface 204. The other components of the example model training circuitry 102 utilize the results/outputs of the comparator 206 to determine whether to and/or how to adjust the sparse ratio and/or block pattern of a layer to generate a trained sparse AI-based model that balances accuracy and performance. Additionally, the comparator 206 determines an accuracy loss ratio based on a ratio of the loss of structure (e.g., the accuracy loss) and the accuracy loss of n in m is greater than a user-selected hyperparameter t (e.g., a threshold corresponding to a user and/or device defined loss target). The comparator 206 can compare the accuracy loss ratio to a hyperparameter to determine if the sparse pattern should be changed for a particular layer.

The example sparse ratio converter circuitry 208 of FIG. 2 adjusts the sparse ratio (e.g., how many weights for a particular layer should correspond to zero) when the accuracy of the AI-based model 104 does not satisfy a threshold and the sparse ratio of the layer is higher than a threshold. For example, the sparse ratio converter circuitry 208 may lower the sparse ratio by reducing the number of zero weights for the layer. For example, to increase sparsity, one of the hyperparameters (e.g., corresponding to pruning, learning rate, etc.) can be adjusted (e.g., lowering a threshold) that causes an increase in sparsity. To reduce the sparse ratio, the one or more of the hyperparameters can be adjusted to decrease sparsity.

The example block pattern converter circuitry 210 of FIG. 2 adjusts the block pattern ratio (e.g., 1 by 8, 1 by 4, 1 by 2, n in m, etc.) when the accuracy of the AI-based model 104 does not satisfy a threshold, the sparse ratio of the layer is higher than a threshold, and the current block size of a layer is above a threshold size. For example, if the initial block pattern for a layer is set to 1 by 16, the block pattern converter circuitry 210 may change the block pattern to a smaller block pattern (e.g., 1 by 8). If the block size of the layer is not above the threshold size (e.g., 1 by 2 or two blocks), the block pattern converter circuitry 210 may utilize an n in m block pattern for the layer.

The example performance estimation circuitry 212 of FIG. 2 estimates the performance of the AI-based model 104. For example, performance estimation circuitry 212 can utilize a kernel to estimate the performance by executing operations such as (1) vmovdqu8 (e.g., move unaligned packed inter values), vbroadcasti32x4 (e.g., broadcast a 4-packed 32-bit integer from a to all elements of dst), vpermt2d (e.g., full permute from two tables overwriting one table), vpshufb (e.g., shuffle bits from quadword elements using byte indexes into mask) (repeated 4 times) and/or (2) vpdpbusd (e.g., multiple and add unsigned and signed bytes) (repeated 16 times). In some examples, the performance estimation circuitry 212 of FIG. 1 can estimate performance of the sparse AI-based model as compared to a dense AI-based model. For example, the performance estimation circuitry 212 can compare a dense GEMM to a 1 by 4 sparse kernel that loads activation matrix before fuse multiply add (FMA) operation. In such an example, for each FMA, the sparse kernel will take 132 cycles (e.g., 4*(3+6+3+1)+16*5), and dense operation reuses the activation block to do the FMA and can ignore the load overhead, resulting in 80 cycles (e.g., 16*5). Thus, the model training circuitry 102 can determine that, for an example sparse ratio of 90%, the maximum performance of a 1 by 4 kernel will be 6.06 (e.g., 100/(100−90)*(80/132)). The 6.06 ratio corresponds to the upper limit of performance (e.g., performance is 6.06 times better than conventional dense AI-based models).

The example compute-to-load calculation circuitry 214 of FIG. 2 determines a compute-to-load ratio for a particular row of a weight tensor as part of the dynamic sparse encoding process. As described above, the higher the compute-to-load ration, the better the hardware efficiency when applying weights to activation values. Accordingly, the compute-to-load calculation circuitry 214 identifies different groupings/tiles of weight elements in a row to identify which grouping will results in the highest compute-to-load calculation. For example, to determine the number of computations, the compute-to-load calculation circuitry 214 multiplies the number of elements in the activation block (e.g., the tile size used for encoding) corresponding to the activation tensor/matrix with the number of non-zero elements in the weight block (e.g., the tile size used for encoding) corresponding to the weight matrix for a determined tiling size. Additionally, to determine the number of loads, the compute-to-load calculation circuitry 214 adds the number of elements in the activation block (e.g., the tile size used for encoding) corresponding to the activation tensor/matrix with the number of non-zero elements in the weight block (e.g., the tile size used for encoding) corresponding to the weight matrix for a determined tiling size. The compute-to-load calculation circuitry 214 determines the compute-to-load ratio by dividing the number of computations (e.g., computations=weight elements*activation elements) by the number of loads. The computer-to-load calculation circuitry 214 determines the compute-to-load for each different configurations of tiling for the column of the weight tensor and identifies the configuration that results in the highest compute-to-load configuration.

The example encoding circuitry 216 of FIG. 2 encodes and/or compresses the weight vector/matrix based on the tiling size selected by thee example compute-to-load calculation circuitry 214. The encoding circuitry 216 can encode the weight/vector matrix by representing items by a strong weight of a relatively small set of neurons (based on the selected tiling size) using one or more sparse encoding/compression algorithm.

The example kernel generation circuitry 218 of FIG. 2 generates a kernel corresponding to specific weights based on the dynamic sparse encoding results. Because there may be different tiling size/configurations for different rows of the weight tensor/matrix (e.g., some tiling sizes being smaller and others being larger), the kernel generation circuitry 218 generates a kernel for each sparse weight to improve efficiency for different sparse matrices. A sparse weight corresponds to a specific encoding result (e.g., different tile size, different index, different column, etc.) Accordingly, the kernel is used to identify and/or facilitate the use of the sparse weight. A kernel (also referred to as computation kernel) is used during an inference process. For example, if the inference is c=a+b, then the addition and the load (a, b)/store (c) process form a kernel and will be called each time for a, b, and c. The kernel generation circuitry can generate the kernel using any kernel generation technique (e.g., using xbyak, just in time compilation, ahead of time, etc.)

While an example manner of implementing the model training circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example interface circuitry 200, the example user interface 204, the example comparator 206, the example sparse ratio converter circuitry 208, the example block pattern converter circuitry 210, the example performance estimation circuitry 212, the example compute-to-load calculation circuitry 214, the example encoding circuitry 216, the example kernel generation circuitry 218, and/or, more generally, the example model training circuitry 102 of FIG. 1, may be implemented by hardware alone or by hardware in combination with software and/or firmware. Thus, for example, any of the example interface circuitry 200, the example user interface 204, the example comparator 206, the example sparse ratio converter circuitry 208, the example block pattern converter circuitry 210, the example performance estimation circuitry 212, the example compute-to-load calculation circuitry 214, the example encoding circuitry 216, the example kernel generation circuitry 218, and/or, more generally, the example model training circuitry 102 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example model training circuitry 102 of FIG. 1 may include one or more elements, processes, and/or devices in addition to, or instead of, those illustrated in FIG. 2, and/or may include more than one of any or all of the illustrated elements, processes, and devices.

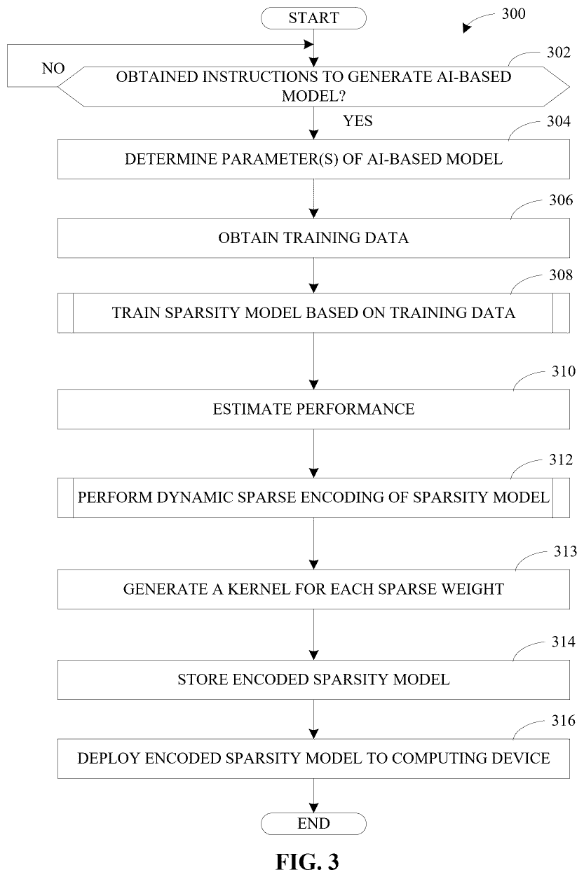

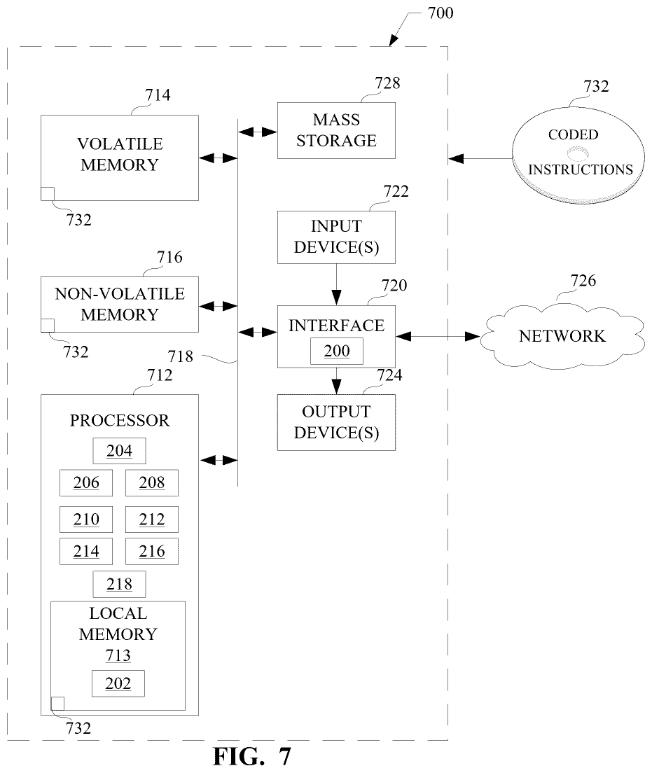

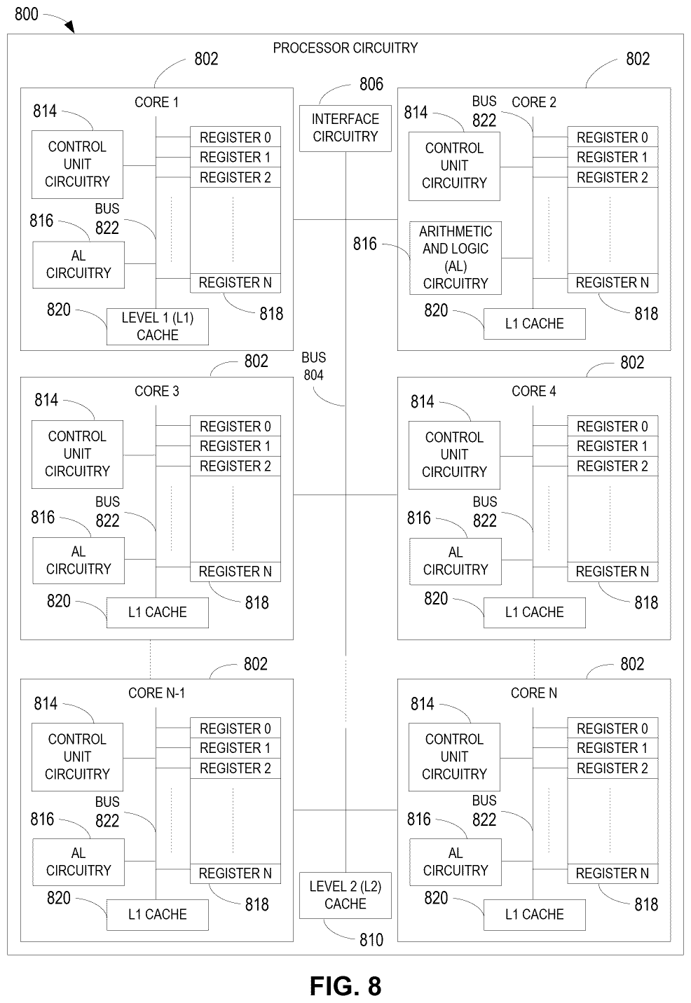

Flowchart representative of example machine readable instructions, which may be executed to configure processor circuitry to implement the model training circuitry 102 of FIG. 2, are shown in FIGS. 3-5. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIG. 3-5, many other methods of implementing the example model training circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to generate and encode a sparse AI-based model. The machine readable instructions and/or the operations 300 of FIG. 3 begin at block 302, at which the user interface 204 and/or the interface circuitry 200 obtains instructions to generate (e.g., train) an AI-based model (e.g., the AI-based model 104 of FIG. 1). For example, if the instructions come from a user, the user interface 204 will obtain the instructions and if the instructions come from another component or device the interface circuitry 200 will obtain the instructions.

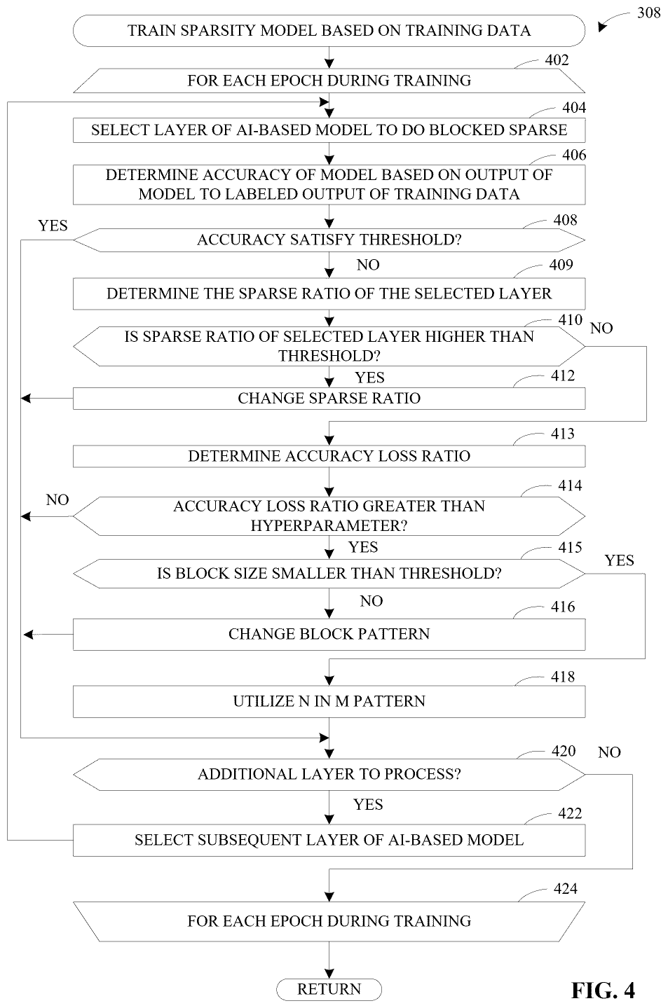

At block 304, the example user interface 204 determines the parameter(s) of the AI-based model. The parameters may include configurations, hyperparameters, threshold values, target accuracy, etc. that a user may select to configure and/or train an AI-based model. At block 306, the example interface circuitry 200 obtains training data from the example training data database 202 to apply to the AI-based model 104 in order to train the AI-based model 104. At block 308, the example model training circuitry 102 trains a sparsity model based on the training data, as further described below in conjunction with FIG. 4.

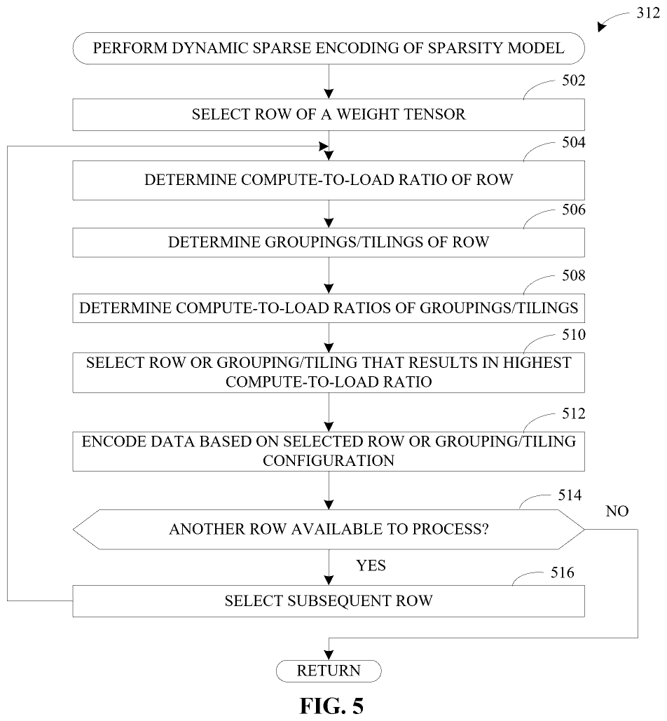

At block 310, the example performance estimation circuitry 212 estimates the performance of the trained sparsity model, as further described above in conjunction with FIG. 2. The training circuitry 102 determines the performance ratio to identify the upper limit of performance gain so that performance can be increased during training of the AI-based model 104. At block 312, the example model training circuitry 102 perform a dynamic sparse encoding of the sparse model, as further described below in conjunction with FIG. 5. At block 313, the example kernel generation circuitry 218 generates a kernel for each sparse weight of the trained AI-based model. At block 314, the example interface circuitry 200 stores the encoded weight information in the example system memory 106 of FIG. 1. At block 316, the example interface circuitry 200 accesses the stored encoded weight information and deploys (e.g., transmits) the encoded sparsity model (e.g., the encoded weight information) to the computing device 114 via the network 112 of FIG. 1.

FIG. 4 is a flowchart representative of example machine readable instructions and/or example operations 308 that may be executed and/or instantiated by processor circuitry to train a sparsity model based on training data. The machine readable instructions and/or the operations 308 of FIG. 4 are performed and/or executed for each epoch during training (blocks 402-424) to determine a hybrid parse pattern for the layers of the AI-based model 104. At block 404, the comparator 206 selects a layer of the AI-based model to apply blocked sparsity.

At block 406, the example comparator 206 determines the accuracy of the AI-based model 104 based on the output of the model and/or the output of the layer and the output included in the labelled data. For example, the comparator 206 determines the accuracy by comparing (e.g., determining a difference) the output of the AI-based model 104 to the intended output of the labelled data to see how close the outputs are. At block 408, the example comparator 206 compares the accuracy (or accuracy drop) to a threshold. If the comparator 206 determines that the accuracy of the AI-based model 104 satisfies (e.g., is above) the threshold (block 408: YES), control continues to block 420. If the comparator 206 determines that the accuracy of the AI-based model 104 does not satisfy (e.g., is below) the threshold (block 408: NO), the example comparator 206 determines the sparse ratio of the selected layer by determining the number of non-zero elements in the layer to the total number of elements of the layer (block 409). At block 410, the example comparator 206 determines if the sparse ratio of the selected layer is higher than a threshold (e.g., a sparse ratio threshold).

If the example comparator 206 determines that the sparse ratio is higher the threshold (block 410: YES), the example sparse ratio converter circuitry 208 changes the sparse ratio (block 412) and control continues to block 420. For example, the sparse ratio converter circuitry may lower the sparse ratio of the to increase the accuracy of the AI-based model 104, as further described above in conjunction with FIG. 2. If the example comparator 206 determines that the sparse ratio is not higher than the threshold (block 410: NO), the example comparator 206 determines an accuracy loss ratio (block 413). The model training circuitry 102 determines an accuracy loss ratio based on a ratio of the loss of structure (e.g., the accuracy loss) and the accuracy loss of the n in m pattern. At block 414, the example comparator 206 determines if the accuracy loss ratio is greater than a hyperparameter t (e.g., a threshold corresponding to a user and/or device defined loss target). If the example comparator 206 determines that the accuracy loss ratio is not greater than the hyperparameter (block 414: NO), control continues to block 420.

If the example comparator 206 determines that the accuracy loss ratio is greater than the hyperparameter (block 414: YES), the example comparator 206 determines if the block size utilized for the selected layer is smaller than a threshold (e.g., a block size threshold) (block 415). The block size may be initiated to a first size (e.g., 1 by 16) and reduced and/or changed to different sizes to increase accuracy. Accordingly, if the example comparator 206 determines that the block size is not smaller than a threshold (block 415: NO), the example block pattern converter circuitry 210 changes the block pattern (e.g., size) used for the layer (e.g., to a smaller size) (block 416) and control continues to block 420. If the example comparator 206 determines that the block size is smaller than a threshold (block 415: YES), the example block pattern converter circuitry 210 changes the block pattern to utilize an n in m pattern (block 418). As described above, n in m block patterns have a higher accuracy at the cost of performance.

At block 420, the example comparator 206 determines if there is an additional layer to process. If the example comparator 206 determines that there is an additional layer to process (block 422: YES), the example comparator 206 selects a subsequent layer of the AI-based model 102 (block 422) and control returns to block 404. If the example comparator 206 determines that there is not an additional layer to process (block 422: NO), an additional epoch is processed and/or control returns to block 310 of FIG. 3.

FIG. 5 is a flowchart representative of example machine readable instructions and/or example operations 312 that may be executed and/or instantiated by processor circuitry to perform dynamic sparse encoding of a sparsity model. The machine readable instructions and/or the operations 312 of FIG. 4 begin at block 502, at which the example compute-to-load calculation circuitry 214 selects a row of a weight tensor.

At block 504, the example compute-to-load calculation circuitry 214 selects a compute-to-load ratio of the selected row. For example, the compute-to-load calculation circuitry 214 determines the compute-to-load ratio by dividing the number of computations required to multiply the activation tile to the weight row by the number of loads required to multiply the activation tile to the weight row. To determine the number of computations required, the compute-to-load calculation circuitry 214 multiplies the number of elements in the activation tile corresponding to the activation tensor/matrix and the number of non-zero elements in the row of the weight matrix. To determine the number of loads required, the compute-to-load calculation circuitry 214 adds the number of elements in the activation tile corresponding to the activation tensor/matrix and the number of non-zero elements in the row of the weight matrix.

At block 506, the example compute-to-load ratio calculation circuitry 214 determines different groupings and/or tiling of the row. For example, the compute-to-load ratio calculation circuitry 214 may tile/group the row into different configurations of tiles/groups (e.g., converting a 1 by 16 row into four 1 by 4 tiles, one 1 by 8 tile and 2 1 by 4 tiles, eight 1 by 2 tiles, and/or any other configuration of tiles). At block 508, the example compute-to-load ratio calculation circuitry 214 determines the compute-to-load ratios of the different groupings and/or tiling. At block 510, the example compute-to-load ratio calculation circuitry 214 selects the row or grouping/tiling that results in the highest compute-to-load ratio, thereby resulting in the highest hardware efficiency when encoding. At block 512, the example encoding circuitry 216 encodes the row of the weight tensor based on the selected row or grouping/tiling configuration.

At block 514, the example compute-to-load calculation circuitry 214 determines if there is another row of the weight tensor/matrix to process/encode. If the example compute-to-load calculation circuitry 214 determines that there is another row to process (block 514: YES), the compute-to-load calculation circuitry 214 selects a subsequent row (block 516) and control return to block 504. If the example compute-to-load calculation circuitry 214 determines that there is not another row to process (block 514: NO), control returns to block 314 of FIG. 3.

FIG. 6 illustrates an example of the dynamic sparse encoding disclosed herein. The example of FIG. 6 includes an example activation tensor 600 (matrix A) and an example weight tensor 602 (matrix B). The AI-based model training circuitry 102 varies the size of the tiling for each row based on the density (e.g., how many non-zero blocks are included in a row), smaller tiles for more dense rows. In the example of FIG. 6, the activation tensor 600 is tiled into 4 by 1 tiles along the M column. For the first row of the weight tensor 602, the example AI-based model training circuitry 102 determines the compute-to-load ratio to be 12/7 and selects the entire row for encoding. For the fifth row of the weight tensor 602, the AI-based model training circuitry 102 determines the compute-to-load of the first tile to be 16/8 (e.g., (4 from M*4 nonzero elements in the first tile of the fifth row)/(4 from M+4 nonzero elements in the first tile of the fifth row)) and determines the compute-to-load of the second tile to be 12/7 (e.g., (4 from M*3 nonzero elements in the first tile of the fifth row)/(4 from M+3 nonzero elements in the first tile of the fifth row)). In some examples, the AI-based model training circuitry 102 may vary the size of the tiling further based on the availability of registers to generate an output.

FIG. 7 is a block diagram of an example processor platform 700 structured to execute the instructions of FIGS. 3-5 to implement the example model training circuitry 102 of FIGS. 1 and/or 2. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 712 implements at least one of the example user interface 204, the example comparator 206, the example sparse ratio converter circuitry 208, the example block pattern converter circuitry 210, the example performance estimation circuitry 212, the example compute-to-load calculation circuitry 214, the example encoding circuitry 216, and the example kernel generation circuitry 218 of FIG. 2.

The processor 712 of the illustrated example includes a local memory 713 (e.g., a cache). In the example of FIG. 7, the local memory 713 implements the example training data database 202 of FIG. 2. The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller. The example local memory 713, the example volatile memory 714, and/or the example non-volatile memory 716 can implement the memory 106 of FIG. 1. Any one of the example volatile memory 714, the example non-volatile memory 716, and/or the example mass storage 728 may implement the example system memory 106 of FIG. 1 and/or the example training data database 202 of FIG. 2.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface. In the example of FIG. 7, the interface 720 implements the example interface circuitry 200 of FIG. 2.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIGS. 3-5 may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a microprocessor 800. For example, the microprocessor 900 may implement multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 3-5.

The cores 802 may communicate by an example bus 804. In some examples, the bus 804 may implement a communication bus to effectuate communication associated with one(s) of the cores 802. For example, the bus 804 may implement at least one of an Inter-Integrated Circuit (I2C) bus, a Serial Peripheral Interface (SPI) bus, a PCI bus, or a PCIe bus. Additionally or alternatively, the bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2_ cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the L1 cache 820, and an example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The bus 820 may implement at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

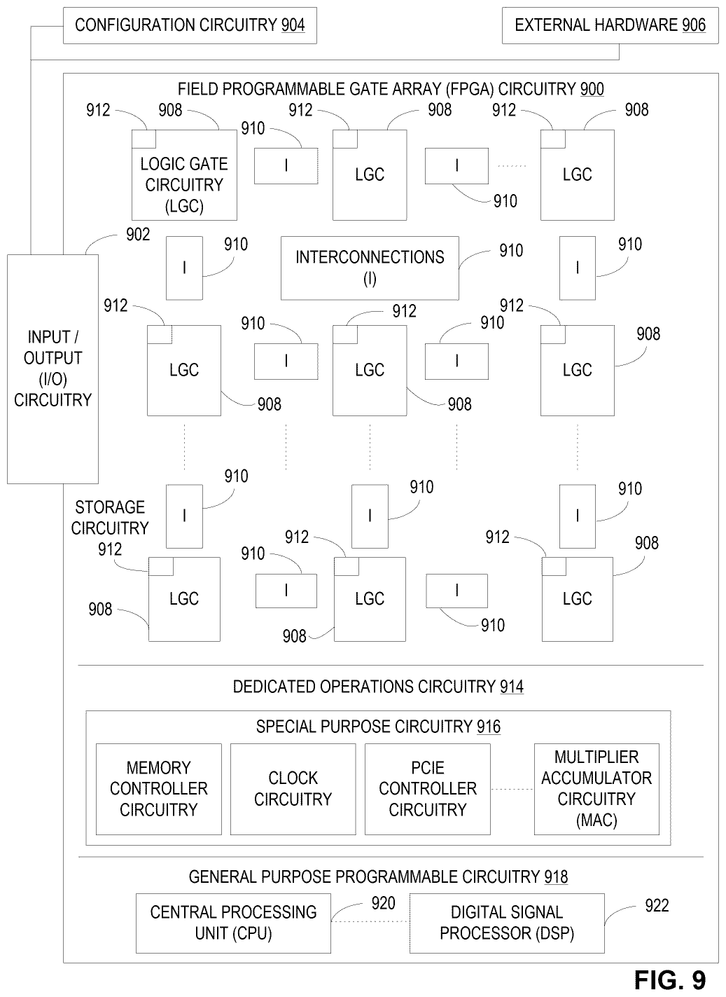

FIG. 9 is a block diagram of another example implementation of the processor circuitry 712 of FIG. 7. In this example, the processor circuitry 712 is implemented by FPGA circuitry 900. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 3-5 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowcharts of FIGS. 3-5. In particular, the FPGA 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowcharts of FIGS. 3-5. As such, the FPGA circuitry 900 may be structured to effectively instantiate some or all of the machine readable instructions of the flowcharts of FIGS. 3-5 as dedicated logic circuits to perform the operations corresponding to those software instructions in a dedicated manner analogous to an ASIC. Therefore, the FPGA circuitry 900 may perform the operations corresponding to the some or all of the machine readable instructions of FIG. FIGS. 3-5 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware (e.g., external hardware circuitry) 906. For example, the configuration circuitry 904 may implement interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. n some examples, the external hardware 906 may implement the microprocessor 800 of FIG. 8. The FPGA circuitry 900 also includes an array of example logic gate circuitry 908, a plurality of example configurable interconnections 910, and example storage circuitry 912. The logic gate circuitry 908 and interconnections 910 are configurable to instantiate one or more operations that may correspond to at least some of the machine readable instructions of FIGS. 3-5 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowcharts of FIGS. 3-5 may be executed by one or more of the cores 802 of FIG. 8 and a second portion of the machine readable instructions represented by the flowcharts of FIGS. 3-5 may be executed by the FPGA circuitry 900 of FIG. 9.

In some examples, the processor circuitry 712 of FIG. 7 may be in one or more packages. For example, the processor circuitry 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

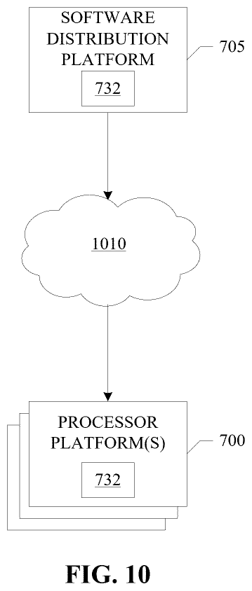

A block diagram illustrating an example software distribution platform 1005 to distribute software such as the example computer readable instructions 732 of FIG. 7 to third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the computer readable instructions 732, which may correspond to the example computer readable instructions 300, 308, 312 of FIGS. 3-5 and 7, as described above. The one or more servers of the example software distribution platform 1005 are in communication with a network 1010, which may correspond to any one or more of the Internet and/or any of the example networks 726 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 732 from the software distribution platform 1005. For example, the software, which may correspond to the example computer readable instructions 732 of FIG. 7, may be downloaded to the example processor platform 1000, which is to execute the computer readable instructions 732 to implement the model training circuitry 102. In some example, one or more servers of the software distribution platform 1005 periodically offer, transmit, and/or force updates to the software (e.g., the example computer readable instructions 732 of FIG. 7) to ensure improvements, patches, updates, etc. are distributed and applied to the software at the end user devices.

Example methods, apparatus, systems, and articles of manufacture to perform artificial intelligence-based sparse computation based on hybrid pattern and dynamic encoding. Further examples and combinations thereof include the following: Example 1 includes an apparatus comprising memory, computer readable instructions, and processor circuitry to execute the computer readable instructions to determine a hybrid sparse pattern of a selected layer of an artificial intelligence (AI)-based model, the hybrid sparse pattern having a sparsity ratio and a block pattern for the selected layer, in response to the sparsity ratio being above a threshold, reduce the sparsity ratio of the selected layer, and in response to the sparsity ratio being below the threshold, adjust the block pattern of the selected layer, the block pattern of the selected layer corresponding to an accuracy ratio.

Example 2 includes the apparatus of example 1, wherein the processor circuitry is to reduce the sparsity ratio by decreasing a number of zero weights for the selected layer.

Example 3 includes the apparatus of example 1, wherein the processor circuitry is to, in response to an n in m pattern of the block pattern of the selected layer being larger than a threshold corresponding to a hyperparameter, adjust the block pattern by reducing a number of elements per block in the selected layer.

Example 4 includes the apparatus of example 3, wherein the processor circuitry is to, in response to a block size corresponding to the block pattern being smaller than a threshold size, adjust the block pattern to the n in m pattern.

Example 5 includes the apparatus of example 1, wherein the processor circuitry is to determine the accuracy ratio based on a comparison of an output of the AI-based model from training data being applied to the AI-based model and a labeled output of the training data.

Example 6 includes the apparatus of example 1, wherein the processor circuitry is to estimate performance of the AI-based model based on a comparison of sparse operation and dense operation corresponding to the AI-based model.

Example 7 includes the apparatus of example 1, wherein the processor circuitry is to generate a kernel for each sparse weight of the selected layer of the AI-based model.

Example 8 includes the apparatus of example 7, wherein the processor circuitry is to dynamically sparse encode the AI-based model by selecting a grouping of data in the AI-based model based on a compute-to-load ratio, and generate the kernel of each sparse weight based on the dynamically encoded AI-based model.

Example 9 includes a non-transitory computer readable medium comprising instructions which, when executed, cause one or more processors to at least determine a hybrid sparse pattern of a selected layer of an artificial intelligence (AI)-based model, the hybrid sparse pattern having a sparsity ratio and a block pattern for the selected layer, in response to the sparsity ratio being above a threshold, reduce the sparsity ratio of the selected layer, and in response to the sparsity ratio being below the threshold, adjust the block pattern of the selected layer, the block pattern of the selected layer corresponding to an accuracy ratio.

Example 10 includes the computer readable medium of example 9, wherein the instructions cause the one or more processors to reduce the sparsity ratio by decreasing a number of zero weights for the selected layer.

Example 11 includes the computer readable medium of example 9, wherein the instructions cause the one or more processors to, in response to an n in m pattern of the block pattern of the selected layer being larger than a threshold corresponding to a hyperparameter, adjust the block pattern by reducing a number of elements per block in the selected layer.

Example 12 includes the computer readable medium of example 11, wherein the instructions cause the one or more processors to in response to a block size corresponding to the block pattern being smaller than a threshold size, adjust the block pattern to the n in m pattern.

Example 13 includes the computer readable medium of example 9, wherein the instructions cause the one or more processors to determine the accuracy ratio based on a comparison of an output of the selected layer from training data being applied to the Ai-based model and a labeled output of the training data.

Example 14 includes the computer readable medium of example 9, wherein the instructions cause the one or more processors to estimate performance of the AI-based model based on a comparison of sparse operation and dense operation corresponding to the AI-based model.

Example 15 includes the computer readable medium of example 9, wherein the instructions cause the one or more processors to generate a kernel for each sparse weight of the selected layer of the AI-based model.

Example 16 includes the computer readable medium of example 15, wherein the instructions cause the one or more processors to dynamically sparse encode the AI-based model by selecting a grouping of data in the AI-based model based on a compute-to-load ratio, and generate the kernel of each sparse weight based on the dynamically encoded AI-based model.

Example 17 includes a method comprising determining, by executing an instruction with one or more processors, a hybrid sparse patterns of layers of an artificial intelligence (AI)-based model, the hybrid sparse patterns having sparsity ratios and block patterns for the layers, if a first sparsity ratio of a first layer is above a threshold, reducing, by executing an instruction with the one or more processors, the first sparsity ratio of the first layer, and if a second sparsity ratio of a second layer is below the threshold, adjusting, by executing an instruction with the one or more processors, a block pattern of the second layer, the block pattern of the selected layer corresponding to an accuracy ratio.

Example 18 includes the method of example 17, wherein the reducing of the first sparsity ratio includes decreasing a number of zero weights for the first layer.

Example 19 includes the method of example 17, wherein the adjusting of the block pattern includes, in response to an n in m pattern of the block pattern of the second layer being larger than a threshold corresponding to a hyperparameter, reducing a number of elements per block in the first layer.

Example 20 includes the method of example 19, wherein the adjusting of the block pattern includes, in response to a block size corresponding to the block pattern being smaller than a threshold size, adjusting the block pattern to the n in m pattern.

Example 21 includes the method of example 17, further including determining the accuracy ratio based on a comparison of an output of the AI-based model from training data being applied to the AI-based model and a labeled output of the training data.

Example 22 includes the method of example 17, further including determining the accuracy ratio based on a comparison of an output of the AI-based model from training data being applied to the AI-based model and a labeled output of the training data.

Example 23 includes the method of example 17, further including estimating performance of the AI-based model based on a comparison of sparse operation and dense operation corresponding to the AI-based model.

Example 24 includes the method of example 17, further including generating a kernel for each sparse weight of at least one of the first or second layers of the AI-based model.

Example 25 includes the method of example 24, further including dynamically sparse encoding the AI-based model by selecting a grouping of data in the AI-based model based on a compute-to-load ratio, and generating the kernel of each sparse weight based on the dynamically encoded AI-based model.

Examples disclosed herein perform artificial intelligence-based sparse computation based on hybrid pattern and dynamic encoding. Examples disclosed herein result in a balance between accuracy and performance based on the configuration and/or characteristics of the AI-based model itself. Additionally, dynamic encoding by tiling based on the density of the rows of a weight vector increases hardware efficiency. Accordingly, the disclosed methods, apparatus and articles of manufacture are accordingly directed to one or more improvement(s) in the functioning of an AI-based model.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
memory;
computer readable instructions; and
processor circuitry to execute the computer readable instructions to:
determine a hybrid sparse pattern of a selected layer of an artificial intelligence (AI)-based model, the hybrid sparse pattern having a sparsity ratio and a block pattern for the selected layer;
based on the sparsity ratio being above a threshold, reduce the sparsity ratio of the selected layer; and
based on the sparsity ratio being below the threshold, adjust the block pattern of the selected layer, the block pattern of the selected layer corresponding to an accuracy ratio.

2. The apparatus of claim 1, wherein the processor circuitry is to reduce the sparsity ratio by decreasing a number of zero weights for the selected layer.

3. The apparatus of claim 1, wherein the processor circuitry is to, based on an n in m pattern of the block pattern of the selected layer being larger than a threshold corresponding to a hyperparameter, adjust the block pattern by reducing a number of elements per block in the selected layer.

4. The apparatus of claim 3, wherein the processor circuitry is to, based on a block size corresponding to the block pattern being smaller than a threshold size, adjust the block pattern to the n in m pattern.

5. The apparatus of claim 1, wherein the processor circuitry is to determine the accuracy ratio based on a comparison of an output of the AI-based model from training data being applied to the AI-based model and a labeled output of the training data.

6. The apparatus of claim 1, wherein the processor circuitry is to estimate performance of the AI-based model based on a comparison of sparse operation and dense operation corresponding to the AI-based model.

7. The apparatus of claim 1, wherein the processor circuitry is to generate a kernel for each sparse weight of the selected layer of the AI-based model.

8. The apparatus of claim 7, wherein the processor circuitry is to:
dynamically sparse encode the AI-based model by selecting a grouping of data in the AI-based model based on a compute-to-load ratio; and
generate the kernel of each sparse weight based on the dynamically encoded AI-based model.

9. A non-transitory computer readable medium comprising instructions which, when executed, cause one or more processors to at least:
determine a hybrid sparse pattern of a selected layer of an artificial intelligence (AI)-based model, the hybrid sparse pattern having a sparsity ratio and a block pattern for the selected layer;
in response to the sparsity ratio being above a threshold, reduce the sparsity ratio of the selected layer; and
in response to the sparsity ratio being below the threshold, adjust the block pattern of the selected layer, the block pattern of the selected layer corresponding to an accuracy ratio.

10. The computer readable medium of claim 9, wherein the instructions cause the one or more processors to reduce the sparsity ratio by decreasing a number of zero weights for the selected layer.

11. The computer readable medium of claim 9, wherein the instructions cause the one or more processors to, in response to an n in m pattern of the block pattern of the selected layer being larger than a threshold corresponding to a hyperparameter, adjust the block pattern by reducing a number of elements per block in the selected layer.

12. The computer readable medium of claim 11, wherein the instructions cause the one or more processors to in response to a block size corresponding to the block pattern being smaller than a threshold size, adjust the block pattern to the n in m pattern.

13. The computer readable medium of claim 9, wherein the instructions cause the one or more processors to determine the accuracy ratio based on a comparison of an output of the selected layer from training data being applied to the Ai-based model and a labeled output of the training data.

14. The computer readable medium of claim 9, wherein the instructions cause the one or more processors to estimate performance of the AI-based model based on a comparison of sparse operation and dense operation corresponding to the AI-based model.

15. The computer readable medium of claim 9, wherein the instructions cause the one or more processors to generate a kernel for each sparse weight of the selected layer of the AI-based model.

16. The computer readable medium of claim 15, wherein the instructions cause the one or more processors to:
dynamically sparse encode the AI-based model by selecting a grouping of data in the AI-based model based on a compute-to-load ratio; and
generate the kernel of each sparse weight based on the dynamically encoded AI-based model.

17. A method comprising:
determining, by executing an instruction with one or more processors, a hybrid sparse patterns of layers of an artificial intelligence (AI)-based model, the hybrid sparse patterns having sparsity ratios and block patterns for the layers;
based on a first sparsity ratio of a first layer is above a threshold, reducing, by executing an instruction with the one or more processors, the first sparsity ratio of the first layer; and
based on a second sparsity ratio of a second layer is below the threshold, adjusting, by executing an instruction with the one or more processors, a block pattern of the second layer, the block pattern of the selected layer corresponding to an accuracy ratio.

18. The method of claim 17, wherein the reducing of the first sparsity ratio includes decreasing a number of zero weights for the first layer.

19. The method of claim 17, wherein the adjusting of the block pattern includes, based on an n in m pattern of the block pattern of the second layer being larger than a threshold corresponding to a hyperparameter, reducing a number of elements per block in the first layer.

20. The method of claim 19, wherein the adjusting of the block pattern includes, based on a block size corresponding to the block pattern being smaller than a threshold size, adjusting the block pattern to the n in m pattern.

21. (canceled)

22. (canceled)

23. (canceled)

24. (canceled)

25. (canceled)
